(19) United States
(12) Patent Application Publication
(10) Pub. No.: US 2021/0332773 A1
(43) Pub. Date: Oct. 28, 2021

(54) PISTON FOR AN INTERNAL COMBUSTION ENGINE HAVING LIQUID METAL COOLING

(71) Applicant: Mahle International GmbH

(72) Inventors: Ulrich Bischofberger, Esslingen (DE); Luca Rederer, Stuttgart (DE); Ulrich Stumkat, Esslingen (DE)

(73) Assignees: Mahle International GmbH, Stuttgart (DE); Mahle International GmbH, Stuttgart (DE)

(21) Appl. No.: 16/624,904

(22) PCT Filed: Jun. 1, 2018
(86) PCT No.: PCT/EP2018/064493

§ 371 Date: Dec. 19, 2019

(30) Foreign Application Priority Data
Jun. 20, 2017 (DE) 102017210282.9

(51) Int. Cl. F02F 3/18; F01P 3/06; C09K 5/06

(52) U.S. Cl. CPC F02F 3/18; C09K 5/066; F01P 3/06

(57) ABSTRACT

A piston for an internal combustion engine may include a piston crown having a closed circumferential cooling channel, a piston skirt, a first metallic coolant arranged in the cooling channel and having a metal or metal alloy with a melting point below 250° C., and a second nonmetallic coolant arranged in the cooling channel and having a melting point below 40° C. and a density which is lower than a density of the first coolant.

### CROSS-REFERENCE TO RELATED APPLICATIONS

This application claims priority to International Patent Application No. PCT/EP2018/064493, filed on Jun. 1, 2018, and German Patent Application No. DE 10 2017 210 282.9, filed on Jun. 20, 2017, the contents of both of which are hereby incorporated by reference in their entireties.

### TECHNICAL FIELD

The invention relates to a piston for an internal combustion engine having a piston crown and a piston skirt, where the piston crown has a closed circumferential cooling channel.

### BACKGROUND

Pistons having liquid metal cooling have the advantage that the liquid coolant is moved within the cooling channel during motion of the piston and the heat can thus be removed very well from the hot places. Liquid metals have the particular advantage that they have a high thermal conductivity and a high heat capacity and can be subjected to significantly higher temperatures than engine oil, so that heat transfer is particularly good.

However, the choice of metals or metal alloys which are liquid at room temperature is restricted either to highly reactive or spontaneously flammable metals, for example alkali metals, metals such as lead, cadmium and mercury which are hazardous to health and would lead to a considerable additional outlay in production and disposal of the pistons or very expensive metals such as indium and gallium. The use of metals which become liquid only at a higher temperature is likewise problematical. It can happen that the piston crown, in particular in the region of the piston bowl, is damaged by the high temperature before the coolant has melted.

### SUMMARY

It is an object of the invention to provide an improved or at least different design for a piston having liquid metal cooling, which is, in particular, characterized in that metals which present a fire hazard or are toxic can be dispensed with.

This object is achieved according to the invention by the subject matter of the independent claim. Advantageous embodiments are subject matter of the dependent claims.

The invention is based on the general idea of arranging a first metallic coolant and a second nonmetallic coolant in the cooling channel. The first coolant comprises a low-melting metal alloy. The second coolant has a melting point below the melting point of the first coolant, preferably a melting point below room temperature. The second coolant serves as starting or auxiliary coolant. It has the effect that even in the starting phase of the internal combustion engine, heat is transferred not only by heat conduction but also by convection from the hot piston crown to the first, still solid, metallic coolant, so that melting of the first main coolant occurs more quickly. The second coolant thus serves to shorten the phase during which the first coolant is not yet liquid and thus cannot yet contribute to convective cooling. The invention therefore provides for a second nonmetallic coolant to be arranged in the cooling channel and for the second coolant to have a melting point below 40° and a density which is lower than a density of the first coolant. As a result, the second coolant floats on the first coolant when the internal combustion engine is switched off and is not enclosed by the first coolant on solidification thereof. The coolant can thus move away in the cooling channel from the starting of the engine and can thus contribute sufficiently to cooling so as to bridge the first starting phase during which the first metallic coolant is not yet molten.

According to the invention, the first coolant has a melting point which is below 250° C. However, an advantageous possibility provides for the melting point of the first coolant to be below 200° C., preferably below 150° C. This can prevent the first coolant from solidifying again during operation at a low engine power. The lower the melting point, the shorter the starting phase in which the first coolant cannot yet contribute to cooling. As a result, a higher power of the internal combustion engine can be tolerated in the first cold-start phase.

A further advantageous possibility provides for the melting point of the second coolant to be below 30°, particularly preferably below 20°. This results in the second coolant being liquid even in the cold-start phase and contributing to cooling and thus being able to accelerate liquefaction of the first coolant.

A further particularly advantageous possibility provides for the first coolant not to comprise any metals which are harmful to health, endanger the environment or ignite spontaneously. In particular, this means that no alkali metals are used as first coolant. Furthermore, no toxic heavy metals such as mercury, cadmium or lead are required either. This assists handling both in production of the pistons and in the disposal of the pistons.

In an advantageous solution, the first coolant comprises tin, bismuth, gallium, indium and/or silver. These metals are nontoxic and relatively unreactive, so that the risk of spontaneous ignition is very small. In addition, these metals alone or in an alloy offer a low melting point.

In a further advantageous solution, the first coolant comprises a tin-bismuth alloy. Such an alloy has a low melting point. Depending on the mixing ratio, the melting point can be lowered down to 138° C. Such a tin-bismuth alloy is therefore very suitable.

In a further particularly advantageous solution, the first coolant comprises a tin-silver alloy. Tin itself has a low melting point of 232° C. This can be decreased further by the addition of silver. Such a tin-silver alloy is therefore likewise advantageous. Other low-melting alloys, in particular ones based on tin or bismuth, including commercial soft solders, which additionally contain proportions of elements such as Ga, In, Pb, Ag or Cu or can be admixed therewith are also advantageous. The intrinsically undesirable metals can be present in small amounts in order to make a further decrease in the melting point possible.

In one advantageous variant, the first coolant comprises an alloy comprising a eutectic mixture of the alloy constituents. Alloys have the lowest melting point in the eutectic mixing ratio, for example Sn42Bi58 with 138° C. or Sn96Ag4 with 221° C. For this reason, at least approximately eutectic mixtures, including those comprising more than two elements, are particularly advantageous for the first coolant.

In a further advantageous variant, the second coolant is thermally stable up to 300° C., preferably up to 400° C. and particularly preferably up to 500° C. This is advantageous because of the high temperatures in an internal combustion engine.

In a further particularly advantageous variant, the second coolant comprises a mixture of biphenyl and diphenyl ether, preferably a eutectic mixture of biphenyl and diphenyl ether. The benzene rings make both biphenyl and diphenyl ether very thermally stable. In particular, such a mixture is still chemically stable at 400° C. Furthermore, this mixture has a melting point of 15° C., so that the second coolant is usable very early, frequently immediately after starting of the engine.

One advantageous possibility provides for the second coolant to comprise silicone oil. Silicone oils are likewise thermally stable. In addition, the desired melting point can be set in a targeted manner.

A further advantageous possibility provides for the second coolant to comprise silicone oil, biphenyl and diphenyl ether. The mixture of these materials enables the properties of the second coolant to be adapted more precisely. It goes without saying that other sufficiently heat-resistant organic materials can also be used as second coolant, for example terphenyls.

In one advantageous solution, the second coolant comprises water. Water has a high thermal stability, a high heat capacity and a low melting point, so that water is very suitable as second coolant. In order to lower the melting point further, salt can be added to the water, so that the second coolant comprises water and a salt. Preference is given to using salts which avoid or only slightly influence a possible reaction of the water with the first coolant or the piston material, for example steel. In order to avoid chemical reactions, preference is given to using pH-neutral salts or at least salts which have only a weakly acidic or weakly basic reaction where possible. Sodium sulfate has been found to be a particularly preferred salt. The use of sodium chloride, sodium nitrate or sodium hydrogenphosphate (Na₂HPO₄) or mixtures of the abovementioned salts is likewise advantageous.

In an advantageous variant, the density of the first coolant is at least 5 times the density of the second coolant, preferably at least 7 times the density of the second coolant. The second coolant is only needed to transport the heat to the first coolant until the latter has melted. When the first coolant is present in liquid form, the second coolant tends to be a hindrance for cooling since it usually has a poorer thermal conductivity than the first metallic coolant. Due to the significantly higher density of the first coolant compared to the second coolant, the first coolant will hurry ahead of the second coolant during the back and forth motion of the piston and largely displace the second coolant from the upper or lower end region of the cooling channel under the influence of inertial forces and thus in the liquid state interact more intensively with the surface of the cooling channel than the second coolant. In this way, the first coolant in the operationally hot state contributes even more greatly to the desired heat transport.

In an advantageous solution, a volume of the first coolant and a volume of the second coolant together occupy at least 10% by volume of a volume of the cooling channel. It has been found that filling of the cooling channel with coolant to an extent of 10% is sufficient to bring about the desired heat transport to a sufficient degree. A volume of the coolants in the cooling channel of 20-40% by volume of the volume of the cooling channel has been found to be particularly advantageous.

In a further advantageous solution, a ratio between the volume of the first coolant and the volume of the second coolant is in the range from 2:1 to 1:3.

Further important features and advantages of the invention may be derived from the dependent claims, from the drawings and from the associated description of figures with the aid of the drawings.

It goes without saying that the abovementioned features and the features still to be explained below can be employed not only in the combination indicated in each case but also in other combinations or alone, without going outside the scope of the present invention.

Preferred working examples of the invention are depicted in the drawings and are explained in more detail in the description below, with identical reference numerals referring to identical or similar or functionally equivalent components.

### BRIEF DESCRIPTION OF THE DRAWINGS

The drawings show, in each case schematically,

FIG. 1 a sectional view through a piston according to the invention,

FIG. 2 a perspective partial sectional view through the piston of FIG. 1.

### DETAILED DESCRIPTION

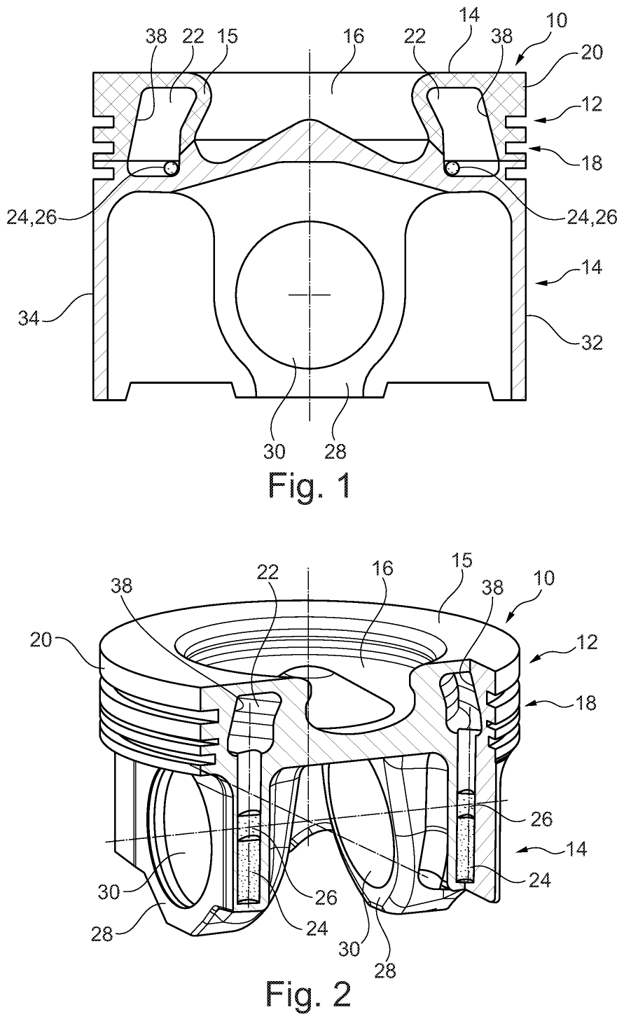

A first embodiment, as depicted in FIGS. 1 and 2, of a piston 10 has a piston crown 12 and a piston skirt 14. The piston crown 12 has a piston top 15 in which a piston bowl 16 is formed. Furthermore, there is a circumferential ring belt 18 into which piston rings can be inserted. At the transition between the ring belt 18 and the piston top 15 there is a top land 20. Furthermore, the piston crown 12 has a closed circumferential cooling channel 22 in which a first coolant 24 and a second coolant 26 are arranged.

The piston skirt 14 adjoins the piston crown 12 in the axial direction. The piston skirt 14 has a boss 28 having two wrist pin holes 30 into which a wrist pin can be inserted in order to attach the piston 10 to a connecting rod of the internal combustion engine. Furthermore, the piston skirt 14 has two running surfaces 32 and 34 which each cover a partial circumference of a cylindrical surface. The two running surfaces 32 and 34 join the two bosses 28.

The piston 10 has a plurality of holes 36 which run essentially axially and open into the cooling channel 22. As a result, the coolant present in the cooling channel 22 can cover a larger distance in the axial direction due to the up and down motion of the piston 10, so that heat transport in the axial direction is improved.

Furthermore, a wall 38 which delimits the cooling channel 22 radially outward and which bears the ring belt 18 is inclined. In particular, the wall 38 is thicker in the vicinity of the piston top 15 than in a region which is closer to the piston skirt 14. As a result, coolant which has been heated up at the piston top 15 does not come into contact with the wall 38 on its way downward, which prevents the wall 38 and thus the ring belt 18 from being heated. Only when the coolant moves from the bottom upward, i.e. out of the holes 36, can it contact the wall 38. However, the coolant which moves from the bottom upward out of the holes 36 has cooled down, so that the wall 38 and the ring belt 18 can be cooled.

The first coolant 24 comprises a metal or a metal alloy which has a melting point which is less than 250° C., preferably less than 200° C. and particularly preferably less than 150° C. When the coolant is solid, it contributes only little to cooling. On the other hand, when the first coolant 24 is liquid, the coolant is moved in the axial direction as a result of the up and down motion of the piston 10, so that the coolant at the piston top 15 can take up heat from the piston top 15 and can transport this away in a downward direction due to the motion. The first coolant 24 can then transfer its heat to the piston skirt 14 in the region of the holes 36. The heat transfer from the piston top 15 to the piston skirt 14 is greatly increased by the convective movement of the first coolant 24. Since the first coolant 24 comprises metal, which has a high thermal conductivity and high heat capacity, the convective heat transfer is very high.

It has been found that when first metallic coolants 24 which have a melting point above 150° C. are used, convective cooling commences too late. This means that in the case of a cold start the piston top 15 which is initially cooled only slightly by conduction of heat can become heated to such an extent that it is damaged before the first coolant 24 melts and can contribute to cooling by convection.

There are metals and metal alloys which have melting points below 100° C. However, these alloys suffer from the problem that metals which ignite spontaneously, are toxic or are very expensive are present therein. The costs of production of such a piston are therefore increased. The use of metals which do not ignite spontaneously, are not toxic and have an acceptable purchase price would reduce the costs of the piston 10.

The second coolant 26 is arranged as auxiliary coolant in the cooling channel 22. The second coolant 26 has a melting point below 40°, preferably below 30° and particularly preferably below 20° C. The second coolant 26 is preferably nonmetallic, so that the second coolant 26 does not form a metallic alloy with the first coolant 24 and therefore would not solidify together with the first coolant 24.

Due to the lower melting point the second coolant 26 can contribute to convective cooling of the piston top 15 even immediately after a cold start of the internal combustion engine. The main task of the second coolant 26 is, however, to ensure that the first coolant 24 melts in good time. Since the second coolant 26 is liquid even in the initial phase, heat energy can be transferred from the piston top 15 to the first coolant 24 and heat the latter quickly enough for the first coolant 24 to ensure sufficient cooling of the piston 10.

Suitable materials for the second coolant 26 are, for example, mixtures of biphenyl and diphenyl ether, preferably eutectic mixtures. As an alternative or in addition, it is also possible to use silicone oils. These compounds have a satisfactory thermal stability of at least 400° C.

To obtain a very low gas pressure during operation of the piston 10, the cooling channel 22 can be either evacuated or filled with dry air, and to decrease the air pressure alkali metals, for example sodium, potassium and/or lithium, can be added in a small amount as alloying constituent to the first coolant 24. Alkali metals react with atmospheric oxygen and lithium also reacts with atmospheric nitrogen to form lithium nitride, so that both the oxygen and the nitrogen are bound firmly in chemical form and the amount of gas in the cooling channel 22 is reduced.

Possible metals or metal alloys for the first coolant 24 are, for example, tin, bismuth and silver. For example, a eutectic mixture of tin and bismuth has a melting point of 138° C. A eutectic mixture of tin and silver has a melting point of 221° C.

1. A piston for an internal combustion engine having, comprising:
a piston crown having a closed circumferential cooling channel;
a piston skirt;
a first metallic coolant arranged in the cooling channel and having a metal or metal alloy with a melting point below 250° C.; and
a second nonmetallic coolant arranged in the cooling channel and having a melting point below 40° C. and a density which is lower than a density of the first coolant.

2. The piston as claimed in claim 1, wherein the metal or metal alloy of the first coolant does not ignite spontaneously.

3. The piston as claimed in claim 1, wherein the first coolant does not comprise any alkali metals or heavy metals.

4. The piston as claimed in claim 1, wherein the first coolant comprises at least one of tin, bismuth, gallium, and silver.

5. The piston as claimed in claim 1, wherein at least one of:
the first coolant comprises a tin-bismuth alloy, and
the first coolant comprises a tin-silver alloy.

6. The piston as claimed in claim 1, wherein the second coolant is thermally stable up to 300° C.

7. The piston as claimed in claim 1, wherein the second coolant comprises biphenyl and diphenyl ether.

8. The piston as claimed in claim 1, wherein the second coolant comprises silicone oil.

9. The piston as claimed in claim 1, wherein the second coolant comprises silicone oil, biphenyl and diphenyl ether.

10. The piston as claimed in claim 1, wherein the second coolant comprises water, in particular salt-containing water.

11. The piston as claimed in claim 1, wherein the density of the first coolant is at least 5 times the density of the second coolant (26).

12. The piston as claimed in claim 1, wherein a volume of the first coolant and a volume of the second coolant together occupy at least 10% by volume of a volume of the cooling channel.

13. The piston as claimed in claim 12, wherein the volume of the first coolant and the volume of the second coolant occupy from 20 to 40% by volume of the volume of the cooling channel.

14. The piston as claimed in claim 1, wherein a volume of the second coolant is less than a volume of the first coolant and greater than half the volume of the first coolant.

15. The piston as claimed in claim 1, wherein a volume of the second coolant is greater than a volume of the first coolant and less than three times the volume of the first coolant.

16. The piston as claimed in claim 6, wherein the second coolant is thermally stable up to 400° C.

17. The piston as claimed in claim 16, wherein the second coolant is thermally stable up to 500° C.

18. The piston as claimed in claim 7, wherein the second coolant comprises a eutectic mixture of biphenyl and diphenyl ether.

19. The piston as claimed in claim 10, wherein the water is salt-containing water.

20. The piston as claimed in claim 11, wherein the density of the first coolant is at least 7 times the density of the second coolant.
